(19) United States
(12) Patent Application Publication
(10) Pub. No.: US 2026/0213302 A1
(43) Pub. Date: Jul. 23, 2026

(54) AN ENCLOSURE

(71) Applicant: LYTEN SWEDEN AB, Stockholm (SE)

(72) Inventors: Hanna WIGGMAN, Stockholm (SE); Oskar LUND, Johanneshov (SE)

(21) Appl. No.: 19/142,518

(22) PCT Filed: Dec. 20, 2023
(86) PCT No.: PCT/EP2023/087003

§ 371 Date: Jun. 23, 2025

(30) Foreign Application Priority Data
Dec. 22, 2022 (SE) 2251559-7

(51) Int. Cl. H01M 10/658; H01M 10/647; H01M 50/211; H01M 50/342; H01M 50/588

(52) U.S. Cl. CPC H01M 10/658; H01M 10/647; H01M 50/211; H01M 50/3425; H01M 50/588

(57) ABSTRACT

An enclosure comprising a plurality of receptacles each to receive a pouch battery cells and wherein each receptacle includes an aperture in a wall of the receptacle to allow material ejected from the pouch battery cell to leave the receptacle, wherein each receptacle includes a thermally insulative barrier configured to be arranged in each receptacle between the respective pouch battery cell and the respective aperture to protect the pouch battery cell of the respective receptacle from material ejected from a different one of the receptacles, wherein the insulative barrier is one or both of: (a) non-fixedly mounted in the receptacle; and (b) frangible; such that in the event of material from a thermal runaway event being ejected from one of the pouch battery cells, the insulative barrier or pieces thereof is configured to be ejected from the receptacle through the aperture with the material from the thermal runaway event.

### FIELD

The present disclosure relates to an enclosure for a plurality of pouch battery cells. The disclosure also relates to a battery module.

### BACKGROUND

Pouch battery cells comprise an electrochemical cell housed within a pouch. The safety of pouch battery cells is important. The electrochemical cell within the pouch may experience thermal runaway, in which there is uncontrolled self-heating. Thermal runaway may be caused by damage to the pouch battery cell. Pressure may build within the pouch during such a thermal runaway event, which may lead to rupture of the pouch and the violent ejection of material. A plurality of pouch battery cells may be mounted together and thus the ejection of material from one of the pouch battery cells presents a hazard to the others.

### SUMMARY

According to a first aspect of the present disclosure there is provided an enclosure for a plurality of pouch battery cells, the enclosure comprising a plurality of receptacles, each receptacle configured to receive a respective one of the plurality of pouch battery cells and wherein each receptacle includes an aperture in a wall of the receptacle to allow material ejected from the pouch battery cell that is mounted in the receptacle to leave the receptacle, wherein each receptacle includes a thermally insulative barrier configured to be arranged in each receptacle between the respective pouch battery cell and the respective aperture to protect the pouch battery cell of the respective receptacle from material ejected from a different one of the receptacles, wherein the insulative barrier is one or both of:
(a) non-fixedly mounted in the receptacle such that in the event of material from a thermal runaway event being ejected from one of the pouch battery cells, the insulative barrier is configured to be ejected from the receptacle through the aperture with the material from the thermal runaway event; and
(b) frangible such that in the event of material from a thermal runaway event being ejected from one of the pouch battery cells, the insulative barrier is configured to break into pieces that are, at least in part, configured to be ejected from the receptacle through the aperture with the material from the thermal runaway event.

In one or more embodiments, the barrier is of a foamed potting material.

In one or more embodiments, the enclosure includes a common channel that extends, longitudinally, alongside each of the plurality of receptacles and wherein two or more of the apertures of each of the plurality of receptacles are configured to open into the common channel.

In one or more embodiments, each receptacle includes a normally-closed cover, the cover configured to adopt an open configuration to reveal the aperture and, in its normally-closed configuration, at least partially close the aperture to prevent material ejected from a different one of the receptacles from entering the receptacle.

In one or more embodiments, each of the barriers comprises a first side and a second side, opposite the first side, wherein the first side is configured to abut or lie directly adjacent the pouch battery cell of the respective receptacle and the second side is configured to abut or lie directly adjacent the cover.

In one or more embodiments, one or more of the covers comprise a cantilevered flap. In some examples, all of the covers comprise cantilevered flaps.

In one or more embodiments, the barrier is configured and arranged to support the cantilevered flap to prevent it opening inwards, into the receptacle.

In one or more embodiments, the wall of the receptacle is configured to surround the pouch battery cell when mounted within the receptacle, and the barrier has a lower mechanical strength than the wall. In one or more embodiments, the wall is of carbon fibre. In one or more embodiments, the aperture comprises a slot extending along a side of the receptacle.

In one or more embodiments, the enclosure is formed of a plurality of trays, each tray comprising a surface and a plurality of side walls extending from outer edges of the surface;
wherein the plurality of trays are configured to stack together and wherein each of the receptacles for receiving the pouch battery cells are defined by spaces between pairs of stacked trays; and
wherein the wall in which the aperture is formed comprises one of the plurality of side walls of each respective tray; and
wherein the barrier of each respective receptacle is configured to fill a gap between said pairs of stacked trays.

In one or more examples, one or more of the covers comprise a flap, wherein the aperture and the flap are formed in a wall of each of the receptacles and wherein each flap is configured such that a free end of the flap is biased such that it prevents material ejected from a different one of the receptacles from entering the receptacle in the normally-closed configuration. In one or more examples, the flap is one of: biased to abut an outside surface of the wall of which it is part; or biased to abut an outside surface of a wall of an adjacent receptacle. In one or more examples, the tray comprises a laminated material having a plurality of layers and wherein the flap of each tray is formed by a region having fewer layers than a neighbouring portion of the tray such that the flap has increased flexibility. In one or more examples, the tray is comprised of carbon fibre layers.

According to a second aspect of the present disclosure there is provided a battery module comprising:
an enclosure according to the first aspect;
a plurality of pouch battery cells;
wherein each receptacle of the enclosure houses one or more of the plurality of pouch battery cells.

While the disclosure is amenable to various modifications and alternative forms, specifics thereof have been shown by way of example in the drawings and will be described in detail.

The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example pouch battery cell;

FIG. 2 shows an example embodiment of an enclosure comprising a plurality of receptacles for receiving pouch battery cells;

FIG. 3 shows an example of one of the plurality of receptacles including an aperture in a wall thereof and an insulative barrier; and

FIG. 4 shows example embodiment of a non-fixedly mounted barrier being ejected through an aperture of one of the receptacles; and

FIG. 5 shows example embodiment of a frangible barrier being ejected through an aperture of one of the receptacles.

### DETAILED DESCRIPTION

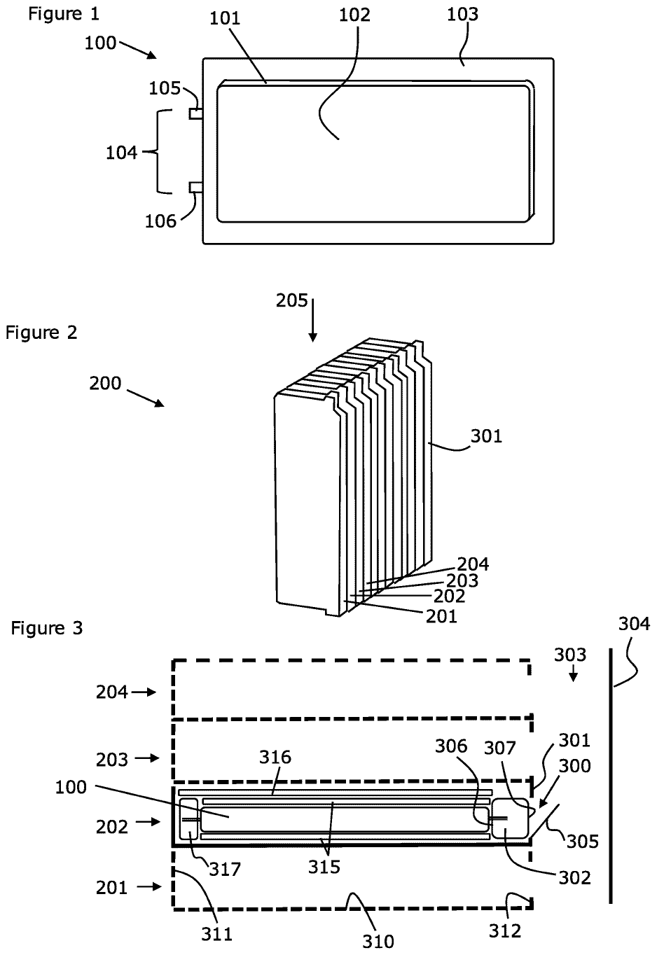

Example FIG. 1 shows a pouch battery cell 100. The pouch battery cell 100 comprises an electrochemical cell and a pouch 101 configured to house the electrochemical cell. It will be appreciated that the electrochemical cell is hidden from view in FIG. 1 due to being housed in the pouch 101 but is located within a section 102. The pouch 101 may be formed of two layers (although further sub-layers may or may not be present) that are sealed together at their peripheral edge to form a peripheral flange 103.

The electrochemical cell may comprise a secondary cell, although the electrochemical cell may be a primary cell or other cell type. As will be familiar to those skilled in the art, the electrochemical cell may comprise an assembly of electrodes and electrolyte for producing and storing electrical energy. In a pouch battery cell the electrodes and electrolyte are typically formed in a series of layers. It will however be appreciated that the form of the electrochemical cell is not the focus in this document.

The pouch battery cell 100 includes at least a first connector arrangement 104 configured to extend through the peripheral flange 103 and provide for electrical connection to the electrochemical cell housed within the pouch 101. Generally, the connector arrangement comprises a positive connector terminal and a negative connector terminal.

It will be appreciated that defects in the electrochemical cell, such as caused by damage or by other reasons, may lead to an increase in heat and pressure within the electrochemical cell that builds up within the pouch 101. As will be known in the art, the pouch battery cell 100 may experience “thermal runaway” in which chemical reactions within the pouch battery cell create temperatures and pressures within the pouch 101 beyond its design limits which will lead to rupture of the pouch 101. The layers of the pouch 101 at the peripheral flange 103 may be forced apart and material from the electrochemical cell may be ejected.

A plurality of pouch battery cells 100 may be arranged together and mounted within an enclosure. It is important, in one or more embodiments, that the enclosure can manage the ejection of materials from a pouch battery cell mounted within it. In one or more embodiments the enclosure may be configured to prevent the material ejected from one pouch battery cell affecting a nearby pouch battery cell. The ejected material may affect a nearby cell for one or more reasons such as by virtue of it being conductive, its temperature, the speed of ejection or the direction of ejection.

FIG. 2 shows an example enclosure 200 for a plurality of pouch battery cells 100. The enclosure 200 comprises a plurality of receptacles 201-204 wherein only four are shown labelled with a reference numeral. Each receptacle 201-204 is configured to receive a respective one of the plurality of pouch battery cells 100. In other examples, one or more or each of the receptacles 201-204 may be configured to receive more than one of the pouch battery cells 100.

FIG. 3 shows a view of the four receptacles 201-204 of the enclosure 200 from one of the ends in the direction of arrow 205. Three of the receptacles are shown empty and only the contents of receptacle 202 is shown in detail, but it will be appreciated that all of the receptacles may be substantially similar. Each receptacle 202 includes an aperture 300 in a wall 301 of the receptacle 202 to allow material ejected from the pouch battery cell 100 that is mounted in the receptacle 202 to leave the receptacle.

In one or more examples, the enclosure 200 includes a common channel 303 that extends, longitudinally, alongside each of the plurality of receptacles 201-204 and wherein the apertures 300 of each of the plurality of receptacles 201-204 are configured to open into the common channel 303. The common channel is defined between the receptacles 201-204 and a channel wall 304. The common channel, in the present examples, comprises a venting channel provided to receive material and gasses ejected from the pouch battery cells 100. In the present example, all of the apertures 300 of each of the plurality of receptacles 201-204 are configured to open into the common channel 303. However, in other examples, only a subset of the apertures 300 open into the common channel. When the apertures 300 of the receptacles 201-204 open into a common channel 303 there is a risk that material ejected from one of the receptacles 201-204 may rebound from the channel wall 304 and impact a different one of the receptacles. The rebounding material could cause further damage to other pouch battery cells 100, which is undesirable. Accordingly, each receptacle 202 includes a thermally insulative barrier 302 configured to be arranged in each receptacle 202 between the respective pouch battery cell 100 and the respective aperture 300 to protect the pouch battery cell 100 of the receptacle 202 from material ejected from a different one 201, 203, 204 of the receptacles. The thermally insulative barrier 302 may protect the pouch battery cell 100 within its receptacle from the heat and hot ejected material caused by a thermal runaway event of a pouch battery cell in a (e.g. directly) neighbouring receptacle.

Optionally, each receptacle 202 includes a normally-closed cover 305 that at least partially closes the aperture 301. The cover 305 may be configured to adopt an open configuration to reveal the aperture 300 and thereby allow material in the receptacle to escape into the channel 303. However, in its normally-closed configuration, the cover 305 at least partially closes the aperture 300 to prevent material ejected from a different one of the receptacles 201, 203, 204 from entering the receptacle 202, in addition to the protection provided by the barrier 302.

In the present examples, the cover 305 comprises a cantilevered flap. In general, however, the cover may comprise any one of: a one-way valve; a localised weakened portion of the receptacle; a rupturable sheet over the aperture 300; a flap configured to close the aperture; and a flap configured to at least partially close the aperture.

The covers 305 may be configured to move to or adopt the open configuration only when a threshold force or pressure is applied to them from within the respective receptacle 201-204. The threshold force or pressure may be based on the force or pressure experienced during a thermal runaway event. After moving to the open configuration the cover 305 may or may not return to the normally-closed position.

Thus, generally, in one or more examples, the flap 305 and aperture 300 may have one or more of the following features. The flap 305 may be biased to close the aperture 300, such as by a spring or by the resilience of the material of which it is made. The flap 305 may be configured and/or arranged to prevent it opening inwards under the force of material ejected from a different one of the receptacles or at all. The barrier 302 may provide this function. As an example, the flap 305 may be biased to abut an outside surface of the wall 301 of the receptacle of which it is part. The flap 305 may be configured to open, such as in an outwards direction, only above a threshold opening force, which may be based on the typical force of ejection of material of a pouch battery cell 100 mounted within the receptacle of which the flap 305 forms part. Thus, there may be a separate structure to manage the venting of gas.

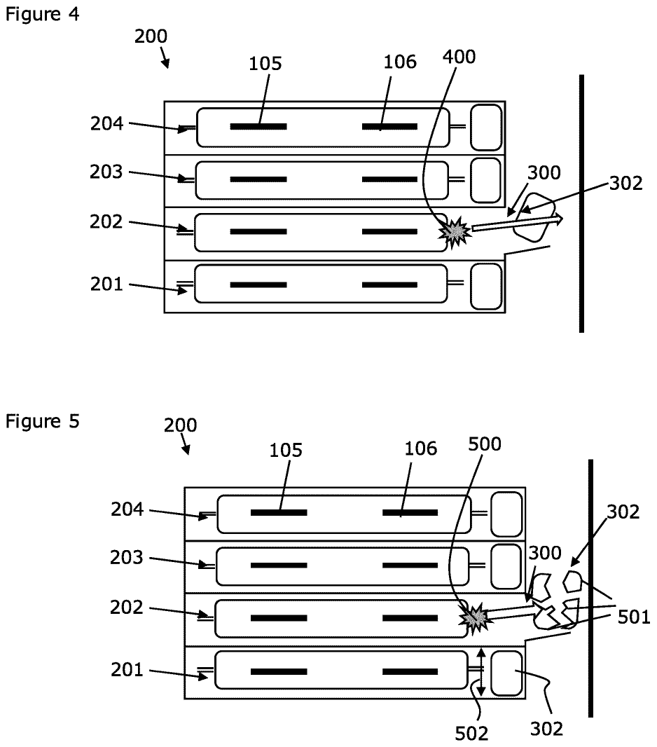

In order to allow for material ejected from a pouch battery cell 100 experiencing thermal runaway to escape from the receptacle 202, the barrier 302 may have one or more properties. In particular, the barrier 302 may be configured or arranged to move from blocking the aperture 300 to thereby provide a path for material and/or gasses from the pouch battery cell 100 to escape through the aperture 300. Example FIGS. 4 and 5 illustrate such properties.

Example FIG. 4 shows the four receptacles 201-204 of the enclosure 200 wherein the pouch battery cell of receptacle 202 is experiencing thermal runaway, designated by star 400.

In this example, the barrier 302 is non-fixedly mounted in the receptacle 202. Thus, the barrier 302 may be loosely fitted in the receptacle 202 such that it is movable when not held in place by other parts. The barrier 302 may be adhered to the receptacle 202 and/or pouch battery cell 100 but the adherence may be such that the barrier is readily parted therefrom. In other examples, the barrier 302 may be mounted in the receptacle 202 by an interference fit but loosely enough to move under the force/pressure of a thermal runaway event occurring in that receptacle.

Thus, upon occurrence of the thermal runaway event 400, the insulative barrier 302 is configured to be ejected from the receptacle 202 through the aperture 300 with the material from the thermal runaway event. This may be advantageous because the barrier 302 may assist in absorbing energy from the thermal runaway event 400 when it is deformed and/or moved to exit through the aperture 300. The barriers 302 of the other receptacles protect the pouch battery cells 100 therein from the heat in the common channel 303.

Example FIG. 5 shows the same four receptacles 201-204 of the enclosure 200 wherein, again, the pouch battery cell of receptacle 202 is experiencing thermal runaway, designated by star 500.

In this example, the barrier 302 is frangible. Accordingly, under the force and/or pressure and/or due to the material ejected by the thermal runaway event 500, the barrier 302 may be of a material or construction such that it breaks into pieces. The barrier 302 may be configured such that the force and/or pressure and/or ejected material may intentionally ablate the barrier 302.

Thus, upon occurrence of the thermal runaway event 500, the insulative barrier 302 is configured to break into pieces 501 that are, at least in part, configured to be ejected from the receptacle 202 through the aperture 300 with the material from the thermal runaway event 500. This may be advantageous because the breaking or ablating of the frangible barrier 302 may absorb at least some of the energy of the thermal runaway event thereby reducing the impact of the event on the neighbouring receptacles and the pouch battery cells therein. Again, the barriers 302 of the other receptacles protect the pouch battery cells 100 therein from the heat in the common channel 303.

In one or more examples, the barrier 302 is of a foamed potting material. A foamed material may conveniently provide the thermally insulative property. The potting may be of thermosetting plastics or silicone rubber or epoxy resin. In one or more examples, the barrier 302, whether or not it is of a foamed potting material, has a thermal conductivity of less than 0.5 W/(m·K), such as less than 0.3 W/(m·K).

It will be appreciated that the barrier 302 may have various properties that allow it to deform and/or move through the aperture 300 and/or break into pieces and/or ablate. For example, the barrier 302 may have one or more of the following material properties: the barrier 302 may have a Shore A hardness of 0 to 80, preferably 20 to 60; and the barrier 302 may have a tensile strength of 5 to 30 MPa, preferably 5 to 16 MPa.

Returning to FIG. 3, the barrier 302 comprises a first side 306 and a second side 307, opposite the first side 306, wherein the first side 306 is configured to abut or lie directly adjacent the pouch battery cell 100 of the respective receptacle. This may act to compress the pouch battery cell 100, which may prevent it swelling. The second side 307 may be configured to abut or lie directly adjacent the cover 305 when in its normally closed position. It will be appreciated that FIG. 3 shows the cover or flap 305 slightly open for clarity.

Accordingly, as can be appreciated in this example embodiment, the insulative barrier 302 is configured and arranged to support the cantilevered flap 305 to prevent it opening inwards, into the receptacle 202. Thus, material ejected from a neighbouring cell and rebounding from the channel wall 304 will be prevented from entering receptacle 202 by the (optional) cover 305 and barrier 302, which may support the cover or flap 305. The barrier 302, being of a thermally insulating material, will also protect the pouch battery cell 100 of receptacle 202 from the heat of any ejected material in the channel 303.

The wall 301 of the receptacle 201-204 is configured to surround the pouch battery cell 100 when mounted within the receptacle. The aperture 300 may comprise a slot extending along a side of the receptacle. The wall 301 may be of carbon fibre.

It will be appreciated that the barrier 302 should not hinder the escape of material and/or gasses from the receptacle so as not to put undue stress on the wall 301. Thus, the barrier 302 is configured to have a lower mechanical strength than the wall 301, such that it thereby directs ejecta into the channel because it will be urged out of the receptable and/or will break or ablate.

In one or more examples, the receptacles 201-204 may be formed of a plurality of trays or “cell carriers” that stack together to form the enclosure 200.

With reference to FIG. 3, each tray comprising a surface 310 and a plurality of side walls 311, 312 extending from outer edges of the surface 310. The plurality of trays stack together, as shown in FIG. 3, wherein the receptacles 201-204 for receiving the pouch battery cells 100 are defined by spaces between pairs of stacked trays. In such an example, the wall 301 in which the aperture 300 is formed comprises one of the plurality of side walls 312 of each tray.

In one or more examples, the barrier 302 may be sized to slide out of the aperture 300, as shown in the example of FIG. 3. Thus, the barrier 302 may be narrower or smaller than the aperture 300. In other examples, the barrier may be of a predetermined compressibility to allow it to deform and exit through the aperture, despite being larger than the aperture in one or more dimensions.

In one or more examples, such as shown in example FIG. 5, the barrier 302 of each respective receptacle is configured to fill a gap 502 between said pairs of stacked trays. In such an example, the barrier 302 may thereby advantageously provide support to the stacked trays in the region directly adjacent the aperture 300.

FIG. 3 shows the receptacle 202 containing a number of layers in addition to the pouch battery cell 100 and the barrier 302. In particular, one or more of the receptacles 201-204 may include a compression material or layer 315 configured to abut the major surfaces of the pouch battery cell to maintain a predetermined compression thereon. The compression material may therefore be resilient. A thermal insulation layer 316 may be provided to provide thermal insulation between receptacles 201-204. A thermal interface paste 317 may be provided at one or more sides of the pouch battery cells 100 such that a effective thermal coupling between the pouch battery cells 100 and a cooling system (not shown but provided on the left-hand side of the enclosures as shown in FIG. 3).

Each tray that forms the receptacles 201-204 may comprise a laminated material having a plurality of layers, such as a carbon fibre laminate. The flaps 305 of each tray or receptacle may be formed by a region having fewer layers than a neighbouring portion or remainder of the tray 401-404 or receptacle 201-204 such that the flap has increased flexibility. Thus, the flap is able to bend. In other examples, the tray may comprise a non-laminated material. In other examples, the flaps 305 may be formed by a weakened section of the receptacle 201-204 or tray to act as a hinge.

It will be appreciated that, with reference to FIGS. 2 to 5, when the enclosure 200 is loaded with pouch battery cells 100 it may form a battery module. Thus, the battery module may comprise an enclosure 200 as described in any of the examples above and a plurality of pouch battery cells 100, wherein each receptacle 201-204 of the enclosure houses one or more of the plurality of pouch battery cells 100. In one or more examples, the pouch battery cells 100 are electrically coupled together or in groups.

1. An enclosure for a plurality of pouch battery cells, the enclosure comprising:
a plurality of receptacles, each receptacle configured to receive a respective one of the plurality of pouch battery cells and wherein each receptacle includes an aperture in a wall of the receptacle to allow material ejected from the pouch battery cell that is mounted in the receptacle to leave the receptacle, wherein each receptacle includes a thermally insulative barrier configured to be arranged in each receptacle between the respective pouch battery cell and the respective aperture to protect the pouch battery cell of the respective receptacle from material ejected from a different one of the receptacles,
wherein the insulative barrier is one or both of:
(a) non-fixedly mounted in the receptacle such that in the event of material from a thermal runaway event being ejected from one of the pouch battery cells, the insulative barrier is configured to be ejected from the receptacle through the aperture with the material from the thermal runaway event; and
(b) frangible such that in the event of material from a thermal runaway event being ejected from one of the pouch battery cells, the insulative barrier is configured to break into pieces that are, at least in part, configured to be ejected from the receptacle through the aperture with the material from the thermal runaway event.

2. The enclosure of claim 1, wherein the barrier is of a foamed potting material.

3. The enclosure of claim 1 wherein the enclosure includes a common channel that extends, longitudinally, alongside each of the plurality of receptacles and wherein two or more of the apertures of each of the plurality of receptacles are configured to open into the common channel.

4. The enclosure of claim 1, wherein each receptacle includes a normally-closed cover, the cover configured to adopt an open configuration to reveal the aperture and, in its normally-closed configuration, at least partially close the aperture to prevent material ejected from a different one of the receptacles from entering the receptacle.

5. The enclosure of claim 4, wherein each of the barriers comprises a first side and a second side, opposite the first side, wherein the first side is configured to abut or lie directly adjacent the pouch battery cell of the respective receptacle and the second side is configured to abut or lie directly adjacent the cover.

6. The enclosure of claim 4, wherein one or more of the covers comprise a cantilevered flap.

7. The enclosure of claim 6, wherein the barrier is configured and arranged to support the cantilevered flap to prevent it opening inwards, into the receptacle.

8. The enclosure of claim 1, wherein the wall of the receptacle is configured to surround the pouch battery cell when mounted within the receptacle, and the barrier has a lower mechanical strength than the wall.

9. The enclosure of claim 1, wherein the wall is of carbon fibre.

10. The enclosure of claim 1, wherein the aperture comprises a slot extending along a side of the receptacle.

11. The enclosure of claim 1, wherein:
the enclosure is formed of a plurality of trays, each tray comprising a surface and a plurality of side walls extending from outer edges of the surface;
the plurality of trays are configured to stack together and wherein each of the receptacles for receiving the pouch battery cells are defined by spaces between pairs of stacked trays;
the wall in which the aperture is formed comprises one of the plurality of side walls of each respective tray; and
the barrier of each respective receptacle is configured to fill a gap between said pairs of stacked trays.

12. A battery module comprising:
the enclosure according to claim 1; and
a plurality of pouch battery cells;
wherein each receptacle of the enclosure houses one or more of the plurality of pouch battery cells.

13. The enclosure of claim 5, wherein one or more of the covers comprise a cantilevered flap.

14. The enclosure of claim 13, wherein the barrier is configured and arranged to support the cantilevered flap to prevent it opening inwards, into the receptacle.

15. The enclosure of claim 13, wherein at least one of:
the wall of the receptacle is configured to surround the pouch battery cell when mounted within the receptacle, and the barrier has a lower mechanical strength than the wall; or
the wall is of carbon fibre.

16. The enclosure of claim 13, wherein the aperture comprises a slot extending along a side of the receptacle.

17. The enclosure of claim 13, wherein the enclosure is formed of a plurality of trays, each tray comprising a surface and a plurality of side walls extending from outer edges of the surface; the plurality of trays are configured to stack together and wherein each of the receptacles for receiving the pouch battery cells are defined by spaces between pairs of stacked trays; the wall in which the aperture is formed comprises one of the plurality of side walls of each respective tray; and the barrier of each respective receptacle is configured to fill a gap between said pairs of stacked trays.
